(19) United States
(12) Patent Application Publication
(10) Pub. No.: US 2009/0071749 A1
(43) Pub. Date: Mar. 19, 2009

(54) Energy-absorbing textile element

(76) Inventors: Marc Burlaud, Morthomiers (FR); Nicolas Faye, Saint-Viatre (FR)

Correspondence Address: Edward G. Greive;Renner, Kenner, Greive, Bobak, Taylor & Weber, Fourth Floor, First National Tower, Akron, OH, 44308-1456, US

(21) Appl. No.: 12/231,746

(22) Filed: Sep. 5, 2008

(30) Foreign Application Priority Data
Sep. 13, 2007 (FR) 07 06416

(51) Int. Cl. A62B 35/00

(52) U.S. Cl. 182/3; 57/210

(57) ABSTRACT

Component of a fall-arrest apparatus, comprising a first element (7), in particular a yarn, extending longitudinally at least between a first point (5) and a second point (6) and a second element (8), in particular a yarn, extending between the first point and the second point, the two elements being subjected to identical tensile forces at the first and second points, characterised in that, in the tensionless state, the longitudinal extension of the second element is greater than the longitudinal extension of the first element.

### TECHNICAL FIELD

The present invention relates to a component of a fall-arrest apparatus such as a safety harness, in particular a web and/or a restraint leash, and also to a fall-arrest apparatus comprising a component of this type.

### BACKGROUND ART

Currently, the webs or the restraint leashes used in fall-arrest apparatuses, such as those comprising a safety harness, are substantially rigid and provide no or hardly any energy-absorbing capacity during a fall of a person wearing the harness, so that it is necessary to add to the apparatus auxiliary energy-absorbing systems which increase the complexity and cost thereof.

### DISCLOSURE OF THE INVENTION

The present invention concerns a component, for example a web or a leash, of a fall-arrest apparatus, comprising for example a safety harness worn by a person who, for example, is working at a high height and who has to be restrained in the event of a fall, which component, as it were, breaks the user's fall and thus prevents the injuries associated with falling, in particular at the end when the speed changes suddenly from fall speed to zero speed.

According to the invention, the component is as defined in claim 1.

Starting from such a component, it is possible to manufacture elements by weaving, knitting, braiding or the like of the component, so as to obtain in a very simple way an element, for example a web, a leash or any other part of a fall arrest apparatus or a fall arrest apparatus itself, having excellent capacities in terms of fall arresting. During a fall, the first element, which is shorter in length, will stretch in part and lengthen under the effect of the falling weight or person, and the second element, which before stretching of the first element comprises a sort of longitudinal play (its length being greater than that of the first element) will assume a shape which is closer to that of the first element and in particular assume a more rectilinear shape, and in particular will become aligned with the stretched first element, and the shock associated with the fall is absorbed by the combined action of these two elements.

Preferably, as the characteristic curve of the first element provides its stretch percentage as a function of the traction force which is applied thereto, it displays, after the resilience range, a constant or slightly increasing traction force elongation range extending along the abscissae over at least 25%, preferably at least 33%, in particular at least 50%, in particular between 25% and 100%.

Preferably, the resilience range is small relative to the constant traction force elongation range, in particular at least 10 times smaller.

Preferably, the resilience range is small, in particular extends over a length along the abscissae of less than 10%, in particular less than 5%.

Preferably, as the characteristic curve of the component or a part of the component provides its stretch percentage as a function of the traction force which is applied thereto, it displays, after the resilience range, a constant or slightly increasing traction force elongation range extending along the abscissae over at least 25%, preferably at least 33%, in particular at least 50%, in particular between 25% and 100%.

Preferably, the resilience range is small relative to the constant traction force elongation range, in particular at least 10 times smaller.

Preferably, the resilience range is small, in particular extends over a length along the abscissae of less than 10%, in particular less than 5%.

In particular, a web or a fall-arrest apparatus leash can be formed by a plurality of “gimped” yarns which are joined together by weaving, knitting or the like.

According to another preferred embodiment of the invention, the first element is a strip-shaped web portion and the second element is a strip-shaped portion, of which the length under vacuum or tensionless length is greater than the length under vacuum or tensionless length of the first strip-shaped element and of which the length is substantially equal to the length of the first strip under maximum stretching.

According to one embodiment, the component is a restraint leash consisting of “gimped” yarns.

According to an improvement, the component comprises a plurality of gimped yarns joined, for example by knitting, weaving, braiding or the like, to form a covering tissue forming a sheath, and in this sheath there is disposed material having a characteristic curve providing its stretch percentage as a function of the traction force which is applied thereto, which displays, after the resilience range, a constant or slightly increasing traction force elongation range extending along the abscissae over at least 25%, preferably at least 33%, in particular at least 50%, in particular between 25% and 100%.

In particular, the material in the sheath is POY.

This type of component is particularly adapted to the case of falls onto a sharp ridge, owing to the combination of the gimped yarns and the stretchable material made, in particular, of POY.

The present invention also relates to a fall-arrest apparatus, in particular comprising a harness, and comprising a component according to the invention, in particular a web or a leash, in particular a restraint leash.

Preferably, the first element is made of POY (partially oriented yarn) and the second yarn of a thermoplastic material, in particular of polyester.

The POY is a yarn made of material conventionally used in spinning, for example a thermoplastic material such as polyester, but which during its manufacture has not been subjected to all of the stretching steps, as described in a large number of US patents, for example U.S. Pat. No. 4,736,500, U.S. Pat. No. 4,736,500, U.S. Pat. No. 4,244,174 and U.S. Pat. No. 4,415,521.

The POY thus remains stretchable without having to apply increasing traction over at least a stretching area such as emerges from its characteristic curve having the shape of that shown in FIG. 4.

### BRIEF DESCRIPTION OF THE DRAWINGS

A description will now be given, by way of example, of the embodiments of the invention which relate to the appended drawings, in which:

FIG. 1a shows a harness comprising a web according to one embodiment of the invention;

FIG. 1b shows a harness comprising a web according to another embodiment of the invention;

FIGS. 2A and 2B are respectively enlarged views of a portion of the webs from FIGS. 1a and 1b;

FIGS. 3A, 3B and 3C show a group of yarns according to the invention in the non-stretched state, then in the stretched state and finally in the woven state of a web;

FIG. 4 shows, for a gimped yarn described hereinbefore or for a portion of the web described hereinbefore, the shape of the curve stretching a portion of the yarn or of the web as a function of the traction force applied at its two ends;

FIG. 5A shows a restraint leash according to the invention;

FIG. 5B is a cross section of the leash from FIG. 5A, and

FIGS. 6, 7 and 8 show various configurations of the tests defined in Annex 1.

### PREFERRED EMBODIMENTS FOR CARRYING OUT THE INVENTION

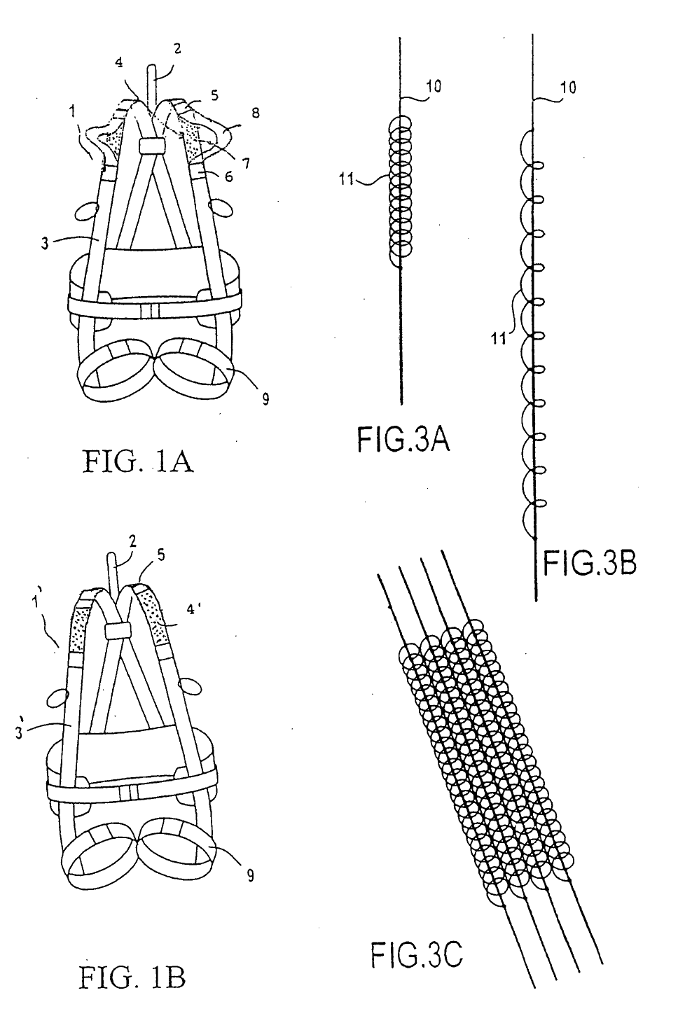

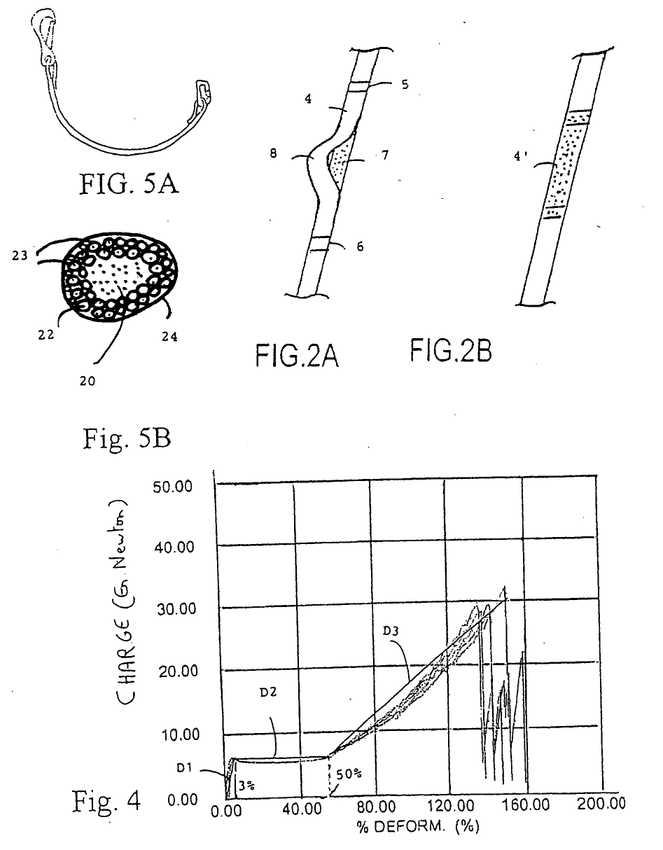

In FIG. 1a, a harness 1 comprises two leg straps 9 intended to surround the thighs of the person wearing the fall-protection safety harness, this harness being connected to a retention apparatus by a connection yarn 2. The harness 1 comprises a plurality of webs, in particular two webs 3 intended to pass over the shoulders of the person wearing the harness, wherein these webs, as a function of the design of the harness, can be configured in various ways and in particular in that shown in FIG. 1. Each web 3 comprises at least one portion 4 extending between two points 5 and 6. This portion 4, between the two points 5 and 6, consists of a first web element 7, the length of which is equal to the length of the web between the two points 5 and 6, and of a second strip-shaped element 8 also extending between the points 5 and 6. The second element 8 is continuous with the remainder of the web and the element 7 is fixed at least at the two points 5 and 6, for example par welding, bonding, knitting, etc., to the remainder of the web, facing the element 8. In order to do this, the web 3 is taken and a sort of loop is formed in order to form the strip part 8 and the strip 7 is then fixed. The total length of the element 8 extending between the points 5 and 6, when disposed rectilinearly, is greater than the length without charge or non-stretched length of the element 7, also when it is disposed rectilinearly.

FIG. 1b shows another possible embodiment in which the web 3′ comprises a portion 4′ which is fixed at its two ends to the web 3′ (once said web has been cut), this portion 4′ being made from gimped yarns, the core of which is made of POY and the sheath, which consists of yarns made of conventional thermoplastic textile material, having been fully stretched during manufacture thereof, the yarns of the sheath between the points 5 and 6 having, when they are disposed rectilinearly, a greater length than the yarn or yarns of the POY core when non-stretched and also disposed rectilinearly.

During a fall, the length of the element 7 (respectively the core of the gimped yarns of the portion 4′) will increase owing to the tension. At the same time, the strip 8 (respectively the yarns forming the sheath of the gimped yarns of the portion 4′) will then tend to approximate the state parallel to the strip 7 (respectively the core of the gimped yarns) by utilising its play associated with its difference in initial length from the strip 7 (respectively the core of the gimped yarns) in the non-stretched state. At the end of the fall, the strip 8 (respectively each sheath yarn) has, in particular if the calculation has been carried out without error, as a function of the weight, the height of the fall, etc., the same length as the element 7 (respectively each core yarn). The cushioning can be such, however, that the element 8 (respectively each sheath yarn), at the end of the fall, still has slight play relative to the strip 7 (respectively the core of the gimped yarns) or, conversely, is stretched somewhat so as to have a length equal to that of the strip 7 when stretched. In particular, the strip 7 of the web is based on gimped yarns comprising a core made of POY or directly of POY, whereas the remainder of the web 3 and the strip 8 are made of a conventional textile material which was fully stretched during manufacture thereof.

FIG. 3A shows a yarn which can be used to produce the web from FIG. 1b which performs the same functions as the set of the two strips of the web portion from FIG. 1a. In order to do this, use is made of two yarns: a first rectilinear yarn 10 and a second yarn 11 wound in the form of helical turns around the first yarn. The yarn 10 extends substantially rectilinearly, whereas the yarn 11 extends remotely from the yarn 10 which has a greater length. The two yarns 10 and 11 form together what is known as a gimped yarn. During a fall, the yarn 10 is stretched and at the same time the yarn 11 unfolds and tends to approach the yarn 10. On the basis of gimped yarns of this type, webs can be produced by weaving or knitting by knitting or weaving the gimped yarns (each consisting of a yarn 10 and a yarn 11), as shown in FIG. 3A or in FIG. 3B, to obtain a woven web, as shown in FIG. 3C, which web can thus be fixed between the points 5 and 6 of the web 1′ to form the portion 4′ or adapted as the strip 7 to the web 1. In this case (FIG. 1a), use may also be made, not of gimped yarns, but rather of yarns made solely of POY, the function of the sheath yarns being performed by the strip 8.

FIGS. 5A and 5B show a restraint leash which is formed by a braiding of gimped yarns, the core of which is made of POY. This leash comprises a central element 20 forming the main core, made of POY, and a sheath consisting of a braiding of gimped yarns 21 surrounding this main core, each gimped yarn having a core 22 made of POY and a sheath 23 consisting of a braiding of yarns made of a conventional textile material, in particular a thermoplastic material, which is not POY, i.e. which has been produced using conventional full stretching methods. Furthermore, the assembly may or may not comprise an additional outer sheath 24 in the form of a tubular web made of polyester, polyamide or another conventional thermoplastic textile material (which is not made of POY, i.e. which has been substantially fully drawn during manufacture thereof). The restraint leash passes the test of falling onto a sharp ridge described in Annex 1 hereinafter.

Preferably, the yarn 10 or the element 7 is made of a material which has a certain stretchability, in particular of POY, i.e. comprises in its curve providing the elongation percentage as a function of the traction force a substantially horizontal level part after the segment corresponding to the resilient part.

It is possible to trace the curve providing the stretch percentage of a yarn, a web or any element as a function of the traction force applied until break.

To produce this curve, use is made of a dynamometer, for example the DY 31 dyanometer having a constant elongation gradient and in accordance with the mode of operation, available from Adamel Lhomargy.

For a yarn number (Dtex) of between 0 and 100, use is made of the 10 N force sensor and the pneumatic pliers equipped with serrated rubber edges and the 10 N-500 mm programme is selected.

For a yarn number (Dtex) of between 100 and 2,000, use is made of the 100 N force sensor and the pneumatic pliers equipped with serrated rubber edges and the 100 N-500 mm programme is selected.

The spacing is subsequently set to 500 mm, then the force sensor is started up and standardised using the conventional “calibration” option.

A sample is then taken of the element to be analysed by selecting a dimension which corresponds to the domain of the yarn size selected, for example a gimped yarn or a plurality of gimped yarns or a strip of a web consisting of a weaving of gimped yarns or of a portion of a leash formed from gimped yarns, and the sample is clamped at its two ends between the jaws of the dynamometer. The stretching force is gradually increased, yielding a curve having the appearance of that shown in FIG. 4.

This curve can be roughly represented in the form of a series of three segments, D1, D2 and D3, and is characteristic of an element according to a preferred embodiment of the invention.

The first segment D1, which is in this case very small, corresponds to the resilient part of the element, the curve of which is being traced. Indeed, the element according to the invention is preferably not resilient or has low resilience. This first segment fans out and extends over a range of from 0 a 10%, in this case up to 3%.

The second segment D2 is substantially horizontal and corresponds to a part in which the element can stretch under substantially constant traction force, or optionally with a slight increase in traction force (the gradient is either zero or low, and in particular smaller than that of the resilient part D1 and than that of the last part D3 described hereinafter).

This second segment D2 corresponds to the elongation of the POY material of the core of the gimped yarn. According to a preferred embodiment of the invention, this segment D2 extends along the axis of the abscissae over at least 25%, preferably at least 33%, in particular at least 50%, for example between 33% and 100%. In the example shown in FIG. 4, it extends over approximately 47%.

Finally, the curve comprises a third segment D3 which has an increasing gradient and stretches until the element breaks. The gradient of this segment D3 is greater than that of the segment D2.

The yarn 11 or the web 8 is preferably made of a thermoplastic material, for example of polyester, Kevlar or polyamide or the like, but all having undergone the conventional stretching steps during manufacture thereof and therefore being less stretchable than the yarn 10 or the element 7.

Preferably, according to the invention, the element has a characteristic curve having the shape of that shown in FIG. 4 and in particular is made of POY. However, there cannot also be provided an element which has a characteristic curve of this type and which in particular might have a second segment of very low extension. This would, for example, be the case for gimped yarns, the core of which was made not of POY but rather of mere thermoplastic material which is fully drawn when spun.

The gimped yarn used may, for example, be the DA 5464 yarn from FILIX, which consists of a 1,180 Dtex PES POY 4/295/66 core representing 51.30% of the composition of the yarn and of two inner and outer covers, each made of 560 Dtex PA 6.6 FTS HT Cordura T440 and each representing 24.30% of the yarn, the gimped yarn having a final yarn number of 4,574 Dtex at +/−7% and the covers having torsion of 1,400 turns per metre at +/−7%.

The gimped yarn used may also be the DA 5664 yarn from FILIX, which consists of a 1,180 Dtex PES POY 4/295/66 core containing 264 filaments and representing 74.60% of the composition of the yarn and of two inner and outer covers, each made of 200 Dtex Nm 1/50 stretch-broken Kevlar and each representing 12.70% of the yarn, the gimped yarn having a final yarn number of 2,152 Dtex at +/−7% and the covers having torsion of 1,500 turns per metre at +/−7%.

### Annex 1

Test equipment requirements and test methods for leashes with an energy absorber when the instructions for use and the label mention a characteristic concerning horizontal use

### B1 Requirements

### B.1.1 Dynamic Performance

When it is subjected to a test in accordance with B.3.1 with a test mass equivalent to the maximum nominal load, but at least 100 kg, the test mass must be maintained and the braking force Fₘₐₓ of the mass must not exceed 6 kN.

### B.1.2 Static Strength

When it is subjected to a test in accordance with B.3.2 with a test force or mass corresponding to 3 times the maximum nominal load, but at least 4.5 kN, the leash with the energy absorber must resist the test force or mass applied over a period of 3_{C}^{G.25}) min.

### B.2 Test Equipment

The test equipment must be in accordance with 4.4, 4.5 and 4.6 of EN 364: 1992.

### B.3 Test Methods

A square bar made of drawn steel in accordance with EN 10278 (material C 45/E 355 GC (ST60) to EN 10025-2) was used as the support ridge. The minimum size of the steel bar must be (10×70) mm and the radius of the ridge (0.5±0.1) mm.

### B.3.1 Dynamic Performance

### B.3.1.1 Sampling

The test samples must comprise the leash and the energy absorber. At least two test samples must be provided.

### B.3.1.2 Test Mode of Operation

A steel chain or cable was attached to the engagement element of the leash and the steel chain or cable was connected to the rigid anchoring point of the test structure. The test mass specified in B.2 was attached with a tolerance

$$( \begin{matrix}+ 1 \\ 0\end{matrix} )$$

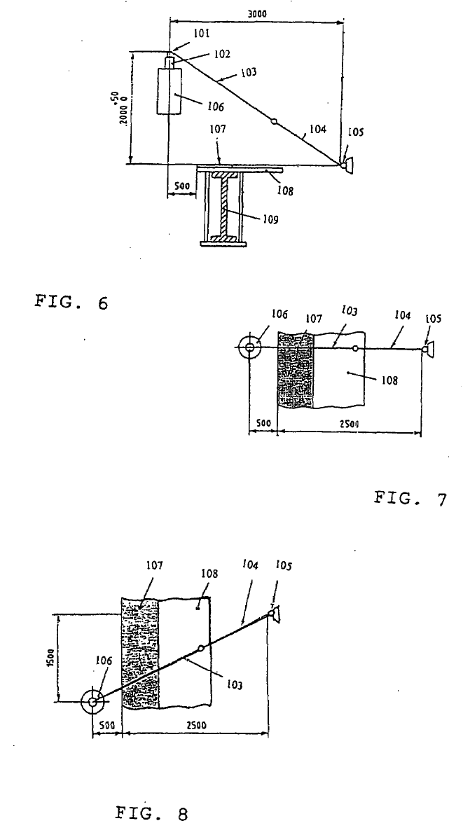

kg, incorporating a force measuring instrument at the other end of the energy absorber.
Two test falls were carried out; the test mass was positioned in one test at right angles to the ridge and in the other with a lateral offset of 1.50 m. A new test sample can be used for each test. Figure B.1 shows the test configuration, in a plan view showing the lateral offset.
The test mass was raised by 2000₀⁵⁰ mm, maximum horizontal distance of 500 mm from the ridge.
The length of the steel chain or cable was adjusted in such a way that the system was quite taut when the test mass was raised.
The test mass was maintained with the aid of the rapid dispensing apparatus.
The test mass was released without initial velocity.
The arrest forces were measured and it was checked that the requirements in B.1.1 had been met.
FIGS. 6 and 7 show the test configuration, respectively in a lateral view and in a plan view at 90° relative to the ridge and to FIG. 8, the test configuration viewed from above, with lateral offset.
The captions to FIGS. 6, 7 and 8 as follows.

### LEGEND

101 Rapid dispensing apparatus
102 Force measuring instrument
103 Leash with energy absorber
104 Steel chain/cable
105 Rigid anchoring point
106 Rigid steel mass
107 Bar
108 Platform
109 Bridge girder

### B.3.2 Static Strength

After the dynamic performance test in accordance with B.3.1, the test mass was replaced by the test mass or force specified in B.1.2 with a tolerance of

$$( \begin{matrix}+ 1 \\ 0\end{matrix} )$$

kg and it was maintained for 3 min at min.

What is claimed is:

1. Component of a fall-arrest apparatus, in particular a restraint leash or a web, comprising a first element (10), a yarn, extending longitudinally at least between a first point (5) and a second point (6) and a second element (11), extending between the first point and the second point, the two elements being subjected to identical tensile forces at the first and second points, characterized in that the second element is a yarn wound in the form of helical turns around the first element, the two yarns forming what is known as a gimped yarn.

2. Component according to claim 1, characterised in that, as the characteristic curve of the first element provides its stretch percentage as a function of the traction force which is applied thereto, it displays, after the resilience range (D1), a constant or slightly increasing traction force elongation range (D2) extending along the abscissae over at least 25%, preferably at least 33%, in particular at least 50%, in particular between 25% and 100%.

3. Component according to claim 2, characterised in that the resilience range (D1) is small relative to the constant traction force elongation range (D2), in particular at least 10 times smaller.

4. Component according to claim 2, characterised in that the resilience range is small, in particular extends over a length along the abscissae of less than 10%, in particular less than 5%.

5. Component according to claim 1, characterised in that the component, in particular a web, is formed by a plurality of “gimped” yarns which are joined together by weaving, knitting or the like.

6. Component according to claim 1, characterised in that the component is a restraint leash consisting of braided “gimped” yarns.

7. Component according to claim 1, characterised in that the component comprises a plurality of gimped yarns joined, for example by knitting, weaving, braiding or the like, to form a covering tissue forming a sheath, and material having a characteristic curve providing its stretch percentage as a function of the traction force which is applied thereto, which displays, after the resilience range, a constant or slightly increasing traction force elongation range extending along the abscissae over at least 25%, preferably at least 33%, in particular at least 50%, in particular between 25% and 100%.

8. Component according to claim 1, characterised in that the first element is made of POY (partially oriented yarn) and the second yarn of a thermoplastic material, in particular of polyester.

9. Fall-arrest apparatus, in particular a harness, comprising a component, in particular a web or a restraint leash, according to claim 1.
